(19) United States
(12) Patent Application Publication
(10) Pub. No.: US 2026/0304154 A1
(43) Pub. Date: Oct. 1, 2026

(54) Wireless Device, Network Node, and Methods Performed Thereby, for Handling an Indication

(71) Applicant: Telefonaktiebolaget LM Ericsson (publ), Stockholm (SE)

(72) Inventors: Jan Christoffersson, Luleå (SE); Oskar Myrberg, Norrköping (SE); Min Wang, Luleå (SE); Revathy Narayanan, Sollentuna (SE)

(21) Appl. No.: 19/476,773

(22) PCT Filed: Apr. 18, 2024
(86) PCT No.: PCT/SE2024/050382

§ 371 Date: Oct. 20, 2025

Related U.S. Application Data
(60) Provisional application No. 63/498,824, filed on Apr. 28, 2023.

(51) Int. Cl. H04W 24/02; H04B 7/06; H04W 68/02; H04W 74/00; H04W 74/0833; H04W 76/20

(52) U.S. Cl. CPC H04W 24/02; H04B 7/0632; H04W 68/02; H04W 74/006; H04W 74/0833; H04W 76/20

(57) ABSTRACT

A method, performed by a wireless device (130), for handling an indication. The wireless device (130) operates in a wireless communications network (100). The wireless device (130) obtains (201) a first indication. The first indication indicates that the wireless device (130) is to report, to a network node (110) operating in the wireless communications network (100), a first indicator of a signal to noise ratio in a channel between the wireless device (130) and the network node (110) in inactive state. The first indication indicates that the wireless device (130) is to report the indicator as part of a procedure to transmit data from the network node (110) to the wireless device (130) while the wireless device (130) is in inactive state. Publ.

### TECHNICAL FIELD

The present disclosure relates generally to a wireless device and methods performed thereby for handling an indication. The present disclosure further relates generally to a network node and methods performed thereby, for handling the indication.

### BACKGROUND

Wireless devices within a wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network (CN), which may be referred to as Next Generation (NG) Core Network, abbreviated as NG-CN, NGC, 5G CN or 5G Core (5GC). NG may be understood to refer to the interface/reference point between the Radio Access Network (RAN) and the CN in 5G/NR. In a 5G System (5GS), a radio base station in NR may be referred to as a gNB or 5G Node B. An NR UE may be referred to as an nUE.

### Internet of Things (IoT)

The Internet of Things (IoT) may be understood as an internetworking of communication devices, e.g., physical devices, vehicles, which may also be referred to as “connected devices” and “smart devices”, buildings and other items—embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices are expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is, a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g., conventional mobile phones and smart phones. In the context of and growth of the IoT, it is evident that MTC traffic will be increasing and thus needs to be increasingly supported in wireless communication systems.

In Rel-17, Mobile Originated Small Data Transmission (MO-SDT) was introduced for NR to reduce the signalling overhead for small uplink data payloads, see RP-200954 ‘New Work Item on NR small data transmissions in INACTIVE state’. Two solutions were introduced concerning Small Data Transmission (SDT), random access based SDT (RA-SDT) and configured grant SDT (CG-SDT). RA-SDT may be understood to mean that either legacy 4-step Random Access CHannel (RACH), or 2-step RACH, procedure may be used as a baseline but that a user-plane data payload may be appended, multiplexed with the RRCResumeRequest message, in Msg3, or MsgA. CG-SDT may be understood to mean that the UEs may be configured via Radio Resource Control (RRC) to have periodic CG-SDT occasions which may, contention-free, be used for uplink transmission. In this way, Msg1 and Msg2 may be omitted but it may be a requirement that the UE has a valid Timing Advance (TA) and is uplink synchronized to be able to use the resources for transmission.

For NarrowBand IoT (NB-IoT) and LTE for Machines (LTE-M), similar signalling optimizations for small data have been introduced through Rel-15 Early Data Transmission (EDT) and Rel-16 Preconfigured Uplink Resources (PUR). The main differences for the NR Small Data Transmission (SDT) solutions may be understood to be that the Rel-17 NR Small Data may be understood to be only to be supported for RRC INACTIVE state, may include also 2-step RACH based small data, that it may be supported by any NR UE, that is, also Mobile Broadband (MBB) UEs and not limited to IoT UEs, and support transmission of subsequent data, that is, larger payload sizes which may require more than one transmission.

LTE support for mobile terminated data (MT) was later introduced in Rel-16, that is, supporting transmissions of small data payloads in the downlink. It may be noted that for NB-IoT and LTE-M, different solutions were introduced for the IoT control-plane optimization, such as ‘Data over Non-Access Stratum (NAS)’ or DoNAS, and IoT user-plane optimizations, such as RRC suspend/resume, Control Plane EDT (CP-EDT) and User Plane EDT (UP-EDT), respectively, and that the NR solutions may be understood to resemble the UP-EDT.

Currently, MT-SDT is being introduced in Rel-18 for NR. A Rel-18 MT-SDT work item description (WID) was approved in RAN #94e, December 2021, and may be found in RP-213583. The WID was updated in RAN #98 (RP-222993). The WID contains as an objective to specify the support for paging-triggered SDT (MT-SDT) [RAN2, RAN3]. Particularly, MT-SDT triggering mechanism for UEs in RRC_INACTIVE, supporting RACH procedure based and CG-SDT procedure based UL response, and MT-SDT procedure for initial DL data reception and subsequent UL/DL data transmissions in RRC_INACTIVE. Data transmission in DL within paging message is not in scope of this WI.

For MO-SDT in release 17, a rough check on the radio environment was introduced, to ensure that MO-SDT was not performed in radio environments that would lead to too many retransmissions on a non-quality controlled link. This may be understood to be to not end up in a situation that may require a lot of extra signalling in RRC_INACTIVE, since it may be more effective for the network to move the UE to RRC_CONNECTED instead. The nature of MO-SDT may be understood to mean that the check may have to be done by the UE before it may make a random access, and by then, there may exist no good estimation of the uplink radio channel. The option chosen may be to perform a measurement of the downlink carriers signal strength, e.g., Reference Signal Received Power (RSRP) and use that as an estimation of the uplink radio channel quality. Even though not perfect, it may keep the UE from attempting MO-SDT in the worst cases.

For MT-SDT, there may probably be a need to perform some estimations of the radio channel as well, and some discussions have been held to re-use the RSRP check as in MO-SDT.

In EDT procedures from release 16, the triggering of a channel quality estimation and reporting in message 3 of the Random Access (RA) procedure was described.

Existing methods to transmit data in the DL to a UE in inactive state may result in wasted signalling and energy resources.

### SUMMARY

As part of the development of embodiments herein, one or more challenges with the existing technology will first be identified and discussed.

Although the received signal strength of the downlink carrier, e.g., RSRP, may give a hint of the current radio conditions to both the UE and the gNB, it may be understood to not consider the signal to noise ratio, and thus, a big part of the DL radio channel is left out of the equation. For the procedures of MT-SDT, there may be understood to be more network control, and there may be room in the procedure for the network to initiate a channel quality, e.g., Channel Quality Indicator (CQI), estimation by the UE and have it reported to the network. There are further problems with different options of how to report a channel quality estimation. For example, the msg3 size is usually limited, by the grant sent from the network, to ensure coverage over the whole cell. If the size is limited, it may not be sufficient space to include the report in msg3 and PUCCH, or transmission in a subsequent message, may be used instead. Or the UE may use preambles group B to obtain a sufficient grant size.

Certain aspects of the present disclosure and their embodiments may provide solutions to these or other challenges.

According to the foregoing, it is an object of embodiments herein to improve the handling of an indication.

According to a first aspect of embodiments herein, the object is achieved by a method, performed by a wireless device. The method is handling an indication. The wireless device operates in a wireless communications network. The wireless device obtains a first indication. The first indication indicates that the wireless device is to report, to the network node operating in the wireless communications network, a first indicator of a signal to noise ratio in a channel between the wireless device and the network node in inactive state. The first indication indicates that the wireless device has to report the first indicator as part of a procedure to transmit data from the network node to the wireless device while the wireless device is in inactive state.

According to a second aspect of embodiments herein, the object is achieved by a method, performed by the first network node. The method is for handling the indication. The first network node operates in the wireless communications network. The first network node receives the report. The receiving is from the wireless device operating in the wireless communications network. The report is of the first indicator of the signal to noise ratio in the channel between the network node and the wireless device, in inactive state. The receiving is as part of the procedure to transmit data from the network node to the wireless device while the wireless device is in inactive state.

According to a third aspect of embodiments herein, the object is achieved by the wireless device, configured to perform the method. The wireless device may be understood to be for handling the indication. The wireless device is configured to operate in the wireless communications network. The wireless device is configured to obtain the first indication. The first indication is configured to indicate that the wireless device is to report, to the network node configured to operate in the wireless communications network, the first indicator of the signal to noise ratio in the channel between the wireless device and the network node in inactive state, as part of a procedure to transmit data from the network node to the wireless device while the wireless device is in inactive state.

According to a fourth aspect of embodiments herein, the object is achieved by the network node, configured to perform the method. The network node may be understood to be for handling the indication. The network node is configured to operate in the wireless communications network. The network node is configured to receive from the wireless device configured to operate in the wireless communications network, the report of the first indicator of the signal to noise ratio in the channel between the network node and the wireless device, in inactive state, as part of the procedure to transmit data from the network node to the wireless device while the wireless device is in inactive state.

By the wireless device obtaining the first indication, the wireless device may be enabled to then determine how to report the first indicator of the signal to noise ratio, e.g., CQI, to the network node in inactive state. This may ensure that the signal to noise ratio may be reported to the network node in an efficient way. Particularly, embodiments herein may enable, e.g., the network node, to indicate to the wireless device that it may have to perform a radio link quality check when initiating the procedure to transmit data from the network node to the wireless device while the wireless device is in inactive state, e.g., MT-SDT, and report it back to the network node before the DL data transmissions may start.

By then receiving the report, the network node may then be enabled to then use this information to either proceed with the procedure, e.g., MT-SDT, and perform link adaptation of the downlink data while the wireless device may remain in inactive state, or move the wireless device to RRC_CONNECTED and serve the wireless device there, if needed.

Further particularly, by enabling to provide the network node information on the signal to noise ratio, as opposed to simply the signal strength, the wireless device may enable the network node to know that if the signal to noise ratio is good, the network node may, for example, perform link adaptation with more aggressive coding and achieve higher throughput. On the contrary, for example, if the signal to noise ratio is poor, the wireless device may enable the network node to know that the network node, for example, may need to perform many retransmissions in inactive state in order to successfully transmit the data to the wireless device, which may negatively affect, e.g, the battery life of the wireless device. The network node may then be enabled to decide to move the wireless device to RRC_CONNECTED and transmit the data to the wireless device after establishing a connection.

### BRIEF DESCRIPTION OF THE DRAWINGS

Examples of embodiments herein are described in more detail with reference to the accompanying drawings, according to the following description.

FIG. 1 is a schematic diagram depicting an example of a wireless communications network, according to embodiments herein.

FIG. 2 is a flowchart depicting a method in a wireless device, according to embodiments herein.

FIG. 3 is a flowchart depicting a method in a network node, according to embodiments herein.

FIG. 4 is a schematic block diagram illustrating an embodiments of a wireless device, according to embodiments herein.

FIG. 5 is a schematic block diagram illustrating an embodiment of a network node, according to embodiments herein.

FIG. 6 is a flowchart depicting a method in a wireless device, according to examples related to embodiments herein.

FIG. 7 is a flowchart depicting a method in a network node, according to examples related to embodiments herein.

FIG. 8 is a schematic block diagram illustrating an example of a communication system 800 in accordance with some embodiments.

FIG. 9 is a schematic block diagram illustrating an example of a UE 900 in accordance with some embodiments.

FIG. 10 is a schematic block diagram illustrating an example of a network node 1000 in accordance with some embodiments.

FIG. 11 is a schematic block diagram illustrating a host 1100, which may be an embodiment of the host 816 of FIG. 8, in accordance with various aspects described herein.

FIG. 12 is a schematic block diagram illustrating an example of a virtualization environment 1200 in which functions implemented by some embodiments may be virtualized.

FIG. 13 shows a communication diagram of a host 1302 communicating via a network node 1304 with a UE 1306 over a partially wireless connection in accordance with some embodiments.

### DETAILED DESCRIPTION

Certain aspects of the present disclosure and their embodiments may provide solutions to the challenges discussed in the Background and Summary sections or other challenges. Embodiments herein may be generally understood relate to a selection of method for early CQI reporting in Inactive, that is in inactive state. Particularly, embodiments herein may relate to an approach that may enable the network to implicitly indicate to the UE that it may have to perform a radio link quality check when initiating the MT-SDT procedure and report it back to the network before the DL data transmissions start. The network may then use this information to either proceed with the MT-SDT procedure and perform link adaptation of the downlink data, or move the UE to RRC_CONNECTED and serve the UE there, if needed. Embodiments herein may be understood to describe how the UE may select between different options of how to report the DL channel quality to the network.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

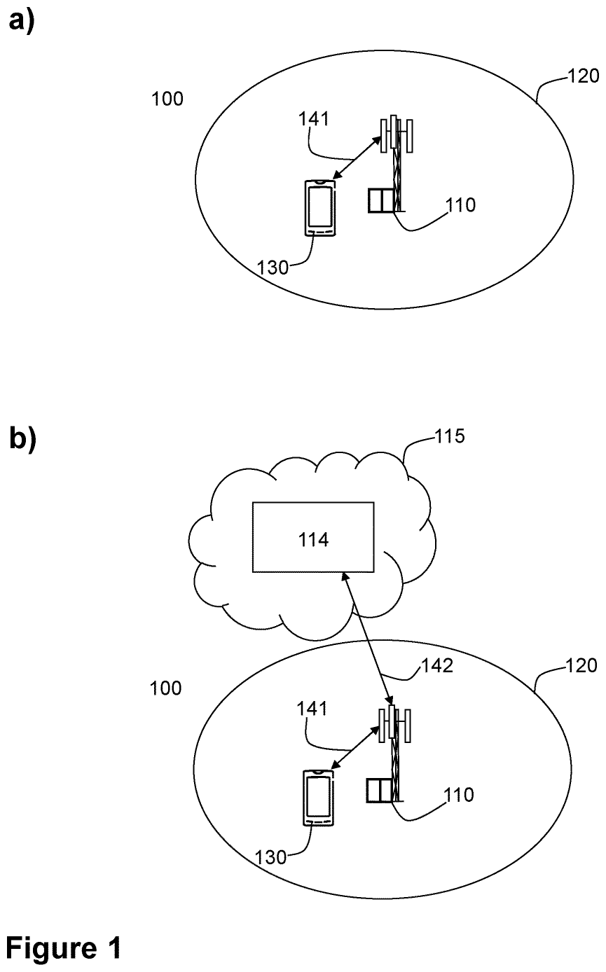

FIG. 1 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System. In other examples, the wireless communications network 100 may be a newer system with similar functionality. Yet in other examples, the wireless communications network 100 may in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced eLAA (eLAA), further enhanced LAA (feLAA) and/or MulteFire. Yet in other examples, the wireless communications network 100 may further support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. The wireless communications network 100 may typically support MTC, enhanced MTC (eMTC), IoT and/or NB-IoT. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes, whereof a network node 110 is depicted in the non-limiting example of FIG. 1. The network node 110 is a radio network node. That is, a transmission point such as a radio base station, for example a gNB, or any other network node with similar features capable of serving a user equipment, such as a wireless device or a machine type communication device, in the wireless communications network 100. In some examples, such as that depicted in FIG. 1 b, the network node 110 may be a distributed node, and may partially perform its functions in collaboration with a virtual node 114 in a cloud 115. The network node 110 may be directly connected to one or more core networks, e.g., to one or more network nodes in the one or more core networks.

The wireless communications network 100 may cover a geographical area, which in some embodiments may be divided into cell areas, wherein each cell area may be served by a radio network node, although, one radio network node may serve one or several cells. In the example of FIG. 1, the network node 110 serves a cell 120. The network node 110 may be of different classes, such as, e.g., macro base station, home base station or pico base station, based on transmission power and thereby also cell size. In some examples, the network node 110 may serve receiving nodes with serving beams. The network node 100 may support one or several communication technologies, and its name may depend on the technology and terminology used.

A plurality of wireless devices may be located in the wireless communication network 100, whereof a wireless device 130, is depicted in the non-limiting example of FIG. 1. The wireless device 130 comprised in the wireless communications network 100 may be a wireless communication device such as a User Equipment (UE), e.g., 5G UE or nUE, which may also be known as e.g., mobile terminal, wireless terminal and/or mobile station, a mobile telephone, cellular telephone, or laptop with wireless capability, just to mention some further examples. The wireless device 130 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. The wireless device 130 comprised in the wireless communications network 100 may be enabled to communicate wirelessly in the wireless communications network 100. The communication may be performed e.g., via a RAN, and possibly the one or more core networks, which may be comprised within the wireless communications network 100.

The wireless device 130 may be configured to communicate within the wireless communications network 100 with the network node 110 over a first link 141, e.g., a radio link. The network node 110 may be configured to communicate within the wireless communications network 100 with the virtual network node 144 over a second link 142, e.g., a radio link or a wired link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first” and/or “second” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a 5G UE, nUE or a UE, and embodiments related to a network node, such as the network node 110, e.g., a gNB.

Some embodiments herein will now be further described with some non-limiting examples, which may be combined with the embodiments just described.

In the following description, any reference to a/the UE, or simply “UE” may be understood to equally refer the wireless device 130; any reference to a/the gNB and/or a/the network may be understood to equally refer to the network node 110; any reference to a/the “cell” may be understood to equally refer to the first cell 121.

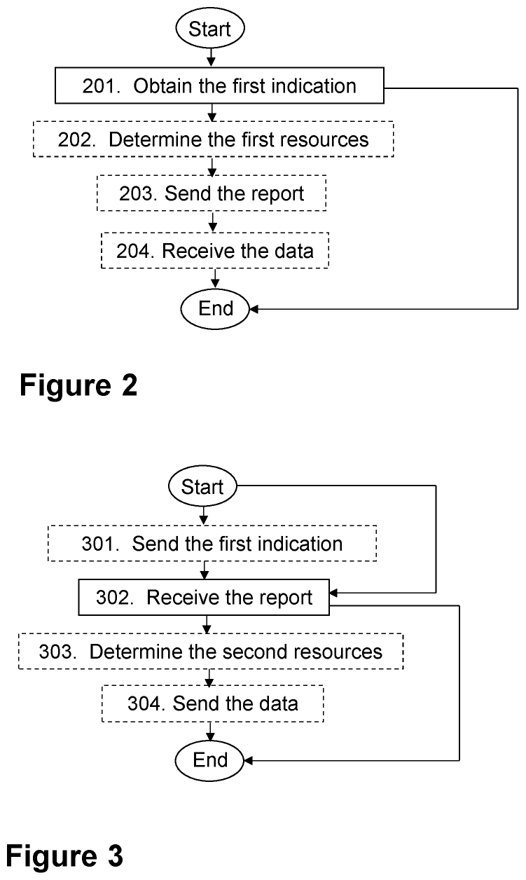

Embodiments of a method, performed by a wireless device, such as the wireless device 130, will now be described with reference to the flowchart depicted in FIG. 2. The method may be understood to be for handling an indication. The wireless device 130 operates in a wireless communications network, such as the wireless communications network 100. The method may be understood to be computer-implemented.

In some embodiments, the wireless communications network 100 may support, or operate in, New Radio (NR).

The method comprises one or more of the following actions. The method comprises Action 201. In some embodiments, all the actions may be performed. In other embodiments, some of the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 2. In FIG. 2 optional actions in some embodiments may be represented with dashed lines. In some embodiments, the actions may be performed in a different order than that depicted FIG. 2.

### Action 201

In this Action 201, the wireless device 130 obtains a first indication.

The first indication indicates that the wireless device 130 is to report, to the network node 110 operating in the wireless communications network 100, a first indicator of a signal to noise ratio in a channel between the wireless device 130 and the network node 110 in inactive state. The first indicator may be of the signal to noise ratio in the channel between the wireless device 130 and the network node 110 in inactive state. The first indication may be understood to indicate that the wireless device 130 is to report the first indicator in inactive state. The first indication may be understood as e.g., an instruction.

The first indication indicates that the wireless device 130 has to report the first indicator as part of a procedure to transmit data from the network node 110 to the wireless device 130 while the wireless device 130 is in inactive state. In some examples, the first indication may indicate that the wireless device 130 has to report the first indicator as part of the procedure to transmit data from the network node 110 to the wireless device 130 while the wireless device is in inactive state, implicitly. That the first indication indicates that the wireless device 130 has to report the first indicator as part of a procedure to transmit data from the network node 110 to the wireless device 130 while the wireless device 130 is in inactive state may be understood to mean that, e.g., after the wireless device 130 may be paged in the procedure and the wireless device 130 may start RA to the network node 110 to receive data from the network node 110, the wireless device 130 may have to report the first indicator to the report to the network node 110. For example, as will be described below, the wireless device 130 may obtain the first indication either from preconfiguration, SI or in a paging message that may be received to trigger the wireless device 130 to perform a RA procedure to enable DL transmission of data from the network node 110 to the wireless device 130 while in inactive state. After paging, the wireless device 130 may start the RA which may comprise UL transmissions, comprising the report, prior to the first DL data.

The channel may be understood to be a radio channel.

The indicator of the signal to noise ratio may be, for example, a Channel Quality Indicator (CQI).

In some examples, the first indication may indicate that the report may need to comprise parameters such as CQI, Release Assistance Information (RAI), multi-Transport Block (multi-TB) scheduling and/or UE assistance information.

The inactive state may be, for example, RRC Inactive state. During inactive state, the wireless device 130 may be understood to be unable to be scheduled for UL or DL data. It may need to do, e.g., SDT.

A size of a buffer comprising the data may be smaller than a first threshold. That is, the data may be small data, e.g., an SDT. In other words, the data may be configured for SDT, e.g., MT-SDT. Accordingly, the procedure to transmit data from the network node 110 to the wireless device 130 while the wireless device 130 is in inactive state may be MT-SDT.

In some embodiments, at least one of the following may apply: a) the report may comprise a CQI, b) the size of a buffer comprising the data may be smaller than the first threshold, c) the data may be configured for SDT and d) the data may be an SDT, terminated at the wireless device 130.

In some embodiments, the first indication may indicate one of the following. According to a first option, the first indication may indicate that the wireless device 130 is to use random access (RA) resources, e.g., legacy random access resources, and report CQI in Msg3 or MsgA. According to a second option, the first indication may indicate that the wireless device 130 is to use RA resources, select a preamble from preamble group B and report CQI in Msg3 or MsgA. This may be understood to mean means that the network node 110 may need to give a larger grant. Without this, the network node 110 may give a minimum grant to guarantee coverage. This minimum grant may not be enough to fit both an RRC message and the indicator, e.g., CQI. In one option, the normal selection thresholds for preambles group B may be not valid. To select preambles group B in legacy, there may need to be more data than a threshold and an RSRP threshold. According to a third option, the first indication may indicate that the wireless device 130 is to use RA-SDT resources and report CQI in Msg3 or MsgA. This may be understood to mean that the wireless device 130 may use e.g., specific preambles, and the network node 110 may provide larger grants for these. The legacy RA resources may not be used, e.g., for the reasons explained above, that is, the grant may be too small. According to a fourth option, the first indication may indicate that the wireless device 130 is to report CQI using Uplink Control Information (UCI) on a Physical Uplink Control Channel (PUCCH). Since this may be understood to not be tied to the RA procedure, the first indication may indicate that the wireless device 130 is to report CQI using UCI on a PUCCH anytime from receiving the page until DL data may be transmitted.

Obtaining may comprise receiving, e.g., via the first link 141, from the network node 110 or another network node, or device, or retrieving, e.g., from a memory.

In some embodiments, the obtaining in this Action 201 of the first indication may be one of: a) in a paging message from the network node 110, b) in a Message 2 of a random access procedure, c) via System Information (SI), d) in an RRCRelease message, e) in a pre-configuration, f) in Downlink Control Information (DCI), and g) in RRC signalling.

In a first example, the wireless device 130, e.g., a UE, may be instructed to perform DL radio channel quality, e.g., CQI, estimation when initiating the MT-SDT procedure and how to report the CQI to the network node 110. In one option, this instruction may be part of the paging message. The instruction may be understood to be the first indication. In another option, the instruction, that is, the first indication, may be part of Msg2. In another option, this may be configured to the wireless device 130, e.g., a UE, in either system information or as part of the RRCRelease message. In yet another option, this may be part of the specification. That is, according to embodiments herein, when the wireless device 130 may be paged to initiate an MT-SDT procedure, the paging message or other message may indicate how to select the first indicator of the signal to noise ratio, e.g., the CQI feedback method. In some options, such as when the obtaining of the first indication may be via SI, in the RRCRelease message, or in the pre-configuration, the network node 110 may indicate to the wireless device 130, for example, that whenever the wireless device 130 may be paged while in inactive state, e.g., as part of an MT-SDT procedure, and the wireless device 130 may perform RA, the wireless device 130 may need to report the indicator to the network node 110, e.g., in Msg. 3, and e.g., how to transmit it.

The instruction, that is, the first indication, may determine which of the below options the wireless device 130 may have to select. According to a first option, option 1, the first indication may indicate to use legacy random access resources and report CQI in Msg3 or MsgA. According to a second option, option 2, the first indication may indicate to use legacy random access resources and select preambles group B and report CQI in Msg3 or MsgA. In one option, the normal selection thresholds for preambles group B may be not valid. According to a third option, option 3, the first indication may indicate to use RA-SDT resources and report CQI in Msg3 or MsgA. According to a fourth option, option 4, the first indication may indicate to report CQI using UCI on PUCCH.

In a second example, when PUCCH may be used for reporting, if the wireless device 130 may be instructed to use the PUCCH for the reporting of the CQI, the instruction, that is, the first indication, may also include or indicate an allocated configuration for this. In one option, the wireless device 130 may use a common PUCCH resource to report CQI. In another option, the wireless device 130 may use a dedicated PUCCH resource to report CQI. In one option, the PUCCH resources may be SDT specific. For either of the options, the wireless device 130 may receive a signaling, e.g., the first indication or another indication, beforehand from the network node 110, e.g., a gNB, which may comprise at least one of the following information: 1) the index of the PUCCH resource, 2) the resource may be a common PUCCH resource or a dedicated PUCCH resource. The index of the PUCCH resource may indicate time and frequency of the PUCCH resource to use for reporting.

The network node 110 may send the signaling, e.g., the first indication or the other indication, to the wireless device 130 via a DCI, paging message or a RRC signaling, e.g., RRCRelease.

In one option, an SDT specific PUCCH may be defined as part of PUCCH-ConfigCommon which may be used during the SDT procedure. The resources reserved as part of this may be used by the MT-SDT UE, that is, a wireless device such as the wireless device 130, which may be configured to support MT-SDT, for sending parameters such as CQI, RAI, multi-TB scheduling and/or UE assistance information in addition to UL ACKnowledgements (ACKs) for the DL data. This may be defined as follows.

### PUCCH-ConfigCommon Information Element

-- ASN1START
-- TAG-PUCCH-CONFIGCOMMON-START

| | |
|---|---|
| PUCCH-ConfigCommon ::= | SEQUENCE { |
| pucch-ResourceCommon | INTEGER (0..15) |

OPTIONAL, -- Cond InitialBWP-Only

| | |
|---|---|
| pucch-GroupHopping | ENUMERATED { neither, enable, disable }, |
| hoppingId | INTEGER (0..1023) |

OPTIONAL, -- Need R

| | |
|---|---|
| p0-nominal | INTEGER (−202..24) |

```
OPTIONAL, -- Need R
  ...,
  [[
```

| | |
|---|---|
| nrofPRBs | INTEGER (1..16) |

OPTIONAL, -- Need R

| | |
|---|---|
| intra-SlotFH-r17 | ENUMERATED {fromLowerEdge, fromUpperEdge} |

OPTIONAL, -- Need R

| | |
|---|---|
| pucch-ResourceCommon-RedCap-r17 | INTEGER (0..15) |

OPTIONAL, -- Need R

| | |
|---|---|
| pucch-ResourceConfig-RedCap-r17 | ENUMERATED {n2, n3, n4, n6, n8, n9, n10, n12} |

OPTIONAL -- Need R

| | |
|---|---|
| pucch-ResourceCommon-SDT-r18 | INTEGER (0..15) |

OPTIONAL -- Need R
]]
}
-- TAG-PUCCH-CONFIGCOMMON-STOP
-- ASN1STOP

PUCCH-ConfigCommon field descriptions

pucch-ResourceCommon-SDT-r18
An entry into a 16-row table where each row configures a set of
cell-specific PUCCH resources/parameters for SDT UEs to be
used while the UE is in the INACTIVE mode.

In a third example, which PUCCH resource to use may be left to implementation of the wireless device 130, e.g., UE implementation. In this case, the wireless device 130 may report CQI using a selected PUCCH resource by the wireless device 130. Since the network node 110 may have no prior knowledge on which PUCCH resource the wireless device 130 may use to report CQI, the network node 110 may have to monitor all configured/preconfigured PUCCH resources. In this option, the transmission from the wireless device 130 may also need to indicate the UE ID, that is an identifier of the wireless device 130, in addition to the CQI report.

Alternatively, the wireless device 130 may map the UCI to a PUSCH transmission when there may be no available PUCCH resource. This may be any one or multiple ones of the following cases. In a first case, the network node 110 may not signal the index of a PUCCH resource to the wireless device 130. In a second case, there may be no common PUCCH resources configured in the cell. In a third case, there may be no dedicated PUCCH resources configured to the wireless device 130. In a fourth case, the PUCCH resource may be expected to not give reliable transmission. The wireless device 130 may have learned this from previous PUCCH transmissions. For example, the wireless device 130 may have recently performed PUCCH transmissions using that/those PUCCH resources, however the transmissions did not reach the network node 110, e.g., the network node 110 did not schedule DL transmissions according to the CQI. In another option of this fourth case, the network node 110 may provide information to the wireless device 130 on the congestion/availability of each PUCCH resource to the wireless device 130. In a fifth case, there may be a possibility to multiplex CQI with the scheduled PUSCH resources. For example, if the CQI is applicable only to subsequent transmissions, e.g., after Msg 4, this may be multiplexed and transmitted along with the PUSCH scheduled for UL data/RAI. In a fourth example, using both PUCCH and PUSCH to report CQI may be used to increase reliability of the CQI reporting. This may be especially advantageous in any of the first-fifth in example 3. This option may be used in case where CQI or RSRP may be below a threshold, which may be referred to herein as a second threshold.

In a fifth example, using PUCCH to report CQI may also be used if the wireless device 130 is instructed to report via option 1) in example 1, but the grant size is not sufficiently large to fit both the RRCResumeRequest and the CQI report. In case UL data may be also available for the UL transmission, using PUCCH to report CQI may also be used if the wireless device 130 is instructed to report via option 3) in example 1, but the grant size is not sufficiently large to fit both the RRCResumeRequest and the CQI report and UL data in Msg3 or MsgA, e.g., and the CQI report has lower priority than the UL data in the Logical Channel Prioritization (LCP) procedure.

In a sixth example, the CQI report may not be included in Msg3 or MsgA if the CQI and/or RSRP is below a threshold, that is, the second threshold. In this case, if the wireless device 130 has been instructed to use option 2) and select preambles group B, the wireless device 130 may instead use option 1) and select preambles group A. In this case, the channel may be understood to be poor, so the network node 110 may not be able to perform any advanced adaptation based on the CQI, that is, it may need to use the most conservative TB size and coding. In such circumstances, the wireless device 130 may refrain from sending the report.

In a sub-example, the threshold, that is, the second threshold, for when to report CQI may be signaled as an offset to the existing MO-SDT RSRP thresholds.

By the wireless device 130 obtaining the first indication in this Action 201, the wireless device 130 may be enabled to then determine, in the next Action 202, how to report the first indicator of the signal to noise ratio, e.g., the CQI, to the network node 110 in inactive state. This may ensure that the CQI may be reported to the network node 110 in an efficient way. Particularly, embodiments herein may enable, e.g., the network node 110, to indicate to the wireless device 130 that it may have to perform a radio link quality check when initiating the MT-SDT procedure and report it back to the network node 110 before the DL data transmissions start. This may in turn enable the network node 110 to then use this information to either proceed with the MT-SDT procedure and perform link adaptation of the downlink data while the wireless device 130 may remain in inactive state, or move the wireless device 130 to RRC_CONNECTED and serve the wireless device 130 there, if needed. Further particularly, by enabling to provide the network node 110 information on the signal to noise ratio, as opposed to simply the signal strength, the wireless device 130 may enable the network node 110 to know that if the signal to noise ratio is good, the network node 110 may, for example, perform link adaptation with more aggressive coding and achieve higher throughput. On the contrary, for example, if the signal to noise ratio is poor, the wireless device 130 may enable the network node 110 to know that the network node 110, for example, may need to perform many retransmissions in inactive state in order to successfully transmit the data to the wireless device 130, which may negatively affect, e.g, the battery life of the wireless device 130. The network node 110 may then be enabled to decide to move the wireless device 130 to RRC_CONNECTED and transmit the data to the wireless device 130 after establishing a connection.

In some embodiments, the method may further comprise one or more of the following actions.

### Action 202

In this Action 202, the wireless device 130 may determine which first resources to use to send the report to the network node 110.

Determining may be understood as calculating, selecting or deriving.

The determining in this Action 202 may be based on the obtained first indication.

It may be understood that any of the options described for the first indication in Action 201 may be used by the wireless device 130 to perform the determination in this Action 202. For example, as mentioned earlier, when PUCCH may be used for reporting, the first indication may indicate the allocated configuration for this.

The determining in this Action 202 of the first resources may be based on one or more conditions, such as for example, whether a signal strength threshold, e.g., RSRP threshold, which may be e.g., the second threshold, may have been exceeded or not.

In seventh example, the wireless device 130 may select/determine which option, PUSCH or PUCCH, to report CQI to the network node 110 based on certain conditions.

As one condition, the wireless device 130 may choose an option based on whether the measured DL radio quality fulfils a threshold, e.g., below or above the threshold, which may be e.g., the second threshold.

As one condition, the wireless device 130 may choose an option based whether the measured DL radio quality is below a threshold, e.g., the second threshold, while higher than another threshold, which may be referred to as a third threshold.

As one condition, the wireless device 130 may choose an option based on whether the number of MT-SDT transmissions towards the wireless device 130 may be above a configured number. This option may require that the wireless device 130 is informed, e.g., by the network node 110, of the size of the DL buffer, for example in the paging message or the Random Access Response (RAR).

As one condition, the wireless device 130 may choose an option based on whether the number of MT-SDT transmissions towards the wireless device 130 may be below a configured number. This option may require that the wireless device 130 may be informed of the size of the DL buffer, for example in the paging message or the RAR.

As one condition, the wireless device 130 may choose an option based on whether the wireless device 130 may have also UL data to transmit, in addition to MT-SDT transmissions towards the wireless device 130 from the network node 110.

As one condition, the wireless device 130 may choose an option based on the priority or Quality of Service (QoS) characteristics of the Data Radio Bearers (DRBs) configured for SDT. If several DRBs are configured for SDT, the wireless device 130 may choose the option based on the DRB with highest priority/QoS requirements or the DRB with the lowest priority/QoS requirements.

In another example, the network node 110 may signal the wireless device 130 the number of, e.g., total/remaining, MT-SDT transmissions towards the wireless device 130 for an on-going MT-SDT session given an assumed Transport Block (TB) size. Alternatively, the wireless device 130 may be informed of the size of the DL buffer, for example in the paging message or the RAR or other signaling.

By the wireless device 130 determining which first resources to use to send the report to the network node 110 in this Action 202, the wireless device 130 may be enabled to select between different options of how to report the DL channel quality to the network node 110.

By the wireless device 130 determining which first resources to use to send the report to the network node 110 in this Action 202 based on the obtained first indication, which may be obtained from the network node 110, the wireless device 130 may be understood to provide the network node 110 control of how the UL radio resources may be used. This is good to not cause collisions and/or congestion on a particular set of resources. The network node 110 may be understood to know the load on the different sets of resources and may be enabled to distribute the use between different wireless devices, thereby optimizing the communications in the wireless communications network 100.

### Action 203

In this Action 203, the wireless device 130 may send the report.

The sending in this Action 203 may be to the network node 110.

The sending in this Action 203 may be, e.g., transmitting, and may be performed, e.g., via the first link 141.

The sending in this Action 203 may be on the determined first resources.

The sending in this Action 203 may be based on the obtained first indication. The sending of the report in this Action 203 may therefore be understood to be performed in inactive state.

In some examples, the report may comprise parameters such as CQI, Release Assistance Information (RAI), multi-Transport Block (multi-TB) scheduling and/or UE assistance information.

In some embodiments, at least one of the following may apply. According to an option, the sending of the report in this Action 203 may be in one of: i) a Message 3 or a Message A of a random access procedure, ii) common or dedicated UCI on a PUCCH, iii) PUCCH resources that may be specific for SDT, iv) PUCCH resources selected autonomously by the wireless device 130, v) a Physical Uplink Shared Channel (PUSCH), and vi) in PUCCH and PUSCH resources. According to another option, the determining in Action 202 of the first resources may be based on the one or more conditions.

In some embodiments, the sending in this Action 203 of the report may be in PUCCH, and the obtained first indication may comprise at least one of: a) the index of the PUCCH resources, b) a second indication of whether resources of the PUCCH are common or dedicated, and c) a PUCCH-ConfigCommon Information Element (IE).

In some embodiments, the wireless device 130 may refrain from sending the report with the proviso a second indicator of a quality of the channel may be below a second threshold. The second indicator may be, e.g., the measured DL radio quality, such as for example RSRP.

By the wireless device 130 sending the report in this Action 203 to the network node 110, based on the first indication, the advantages described in relation to Action 201 may be achieved. That is, the wireless device 130 may ensure that the first indicator of the signal to noise ratio, e.g., the CQI, may be reported to the network node 110 in an efficient way, before the DL data transmissions start. This may in turn enable the network node 110 to then use this information to either proceed with the MT-SDT procedure and perform link adaptation of the downlink data while the wireless device 130 may remain in inactive state, or move the wireless device 130 to RRC_CONNECTED and serve the wireless device 130 there, if needed. If the signal to noise ratio is good, the network node 110 may perform link adaptation with more aggressive coding and achieve higher throughput. On the contrary, for example, if the signal to noise ratio is poor, the wireless device 130 may enable the network node 110 to know that the network node 110 may need to perform many retransmissions in inactive state in order to successfully transmit the data to the wireless device 130, which may negatively affect, e.g, the battery life of the wireless device 130. The network node 110 may then be enabled to decide to move the wireless device 130 to RRC_CONNECTED and transmit the data to the wireless device 130 after establishing a connection.

### Action 204

In this Action 204, the wireless device 130 may receive the data, e.g., SDT.

The receiving in this Action 204 may be from the network node 110. The data may therefore be, e.g., MT-SDT.

The receiving in this Action 204 may be performed, e.g., via the first link 141.

The receiving in this Action 204 may be based on the sent report. For example, if the CQI indicates the quality of the channel is considered to be good, data may be received in inactive state, e.g., as MT-SDT. If the report indicates the quality of the channel is considered to be poor, in order to avoid manty retransmissions in inactive state, the wireless device 130 may be moved first to the connected state and then receive the data once connected to the network node 110 in connected state.

Embodiments of a method, performed by a network node, such as the network node 110 will now be described with reference to the flowchart depicted in FIG. 3. The method may be understood to be for handling the indication. The network node 110 operates in a wireless communications network, such as the wireless communications network 100. The method may be understood to be computer-implemented.

In some embodiments, the wireless communications network 100 may support NR.

The first method may comprise one or more of the following actions. In a particular non-limiting example, Action 301 may be performed. In some embodiments, all the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the network node 110 is depicted in FIG. 3. In FIG. 3, optional actions in some embodiments may be represented with dashed lines. In some embodiments, the actions may be performed in a different order than that depicted FIG. 3.

The detailed description of some of the following corresponds to the same references provided above, in relation to the actions described for the wireless device 130 and will thus not be repeated here to simplify the description. For example, the data may be SDT.

### Action 301

In this Action 301, the network node 110 may send the first indication.

The sending in this Action 301 may be to the wireless device 130.

The sending in this Action 301 may be performed, e.g., via the first link 141.

The first indication may indicate that the wireless device 130 is to report to the network node 110, the first indicator.

The first indicator is of the signal to noise ratio in the channel between the network node 110 and the wireless device 130 in inactive state.

The sending in this Action 301 of the first indication may be performed as part of the procedure to transmit data from the network node 110 to the wireless device 130 while the wireless device 130 is in inactive state.

The first indication may indicate that the wireless device 130 may have to report the first indicator as part of a procedure to transmit data from the network node 110 to the wireless device 130 while the wireless device 130 is in inactive state.

The size of the buffer comprising the data may be smaller than the threshold. That is, the data may be configured for SDT.

The sending in this Action 301 of the first indication may be one of: a) in the paging message from the network node 110, b) in the Message 2 of the random access procedure, c) via the SI, d) in the RRCRelease message, e) in the pre-configuration, f) in the DCI, and g) in the RRC, signalling.

In some embodiments, at least one of the following may apply: a) the report may comprise the CQI, b) the size of the buffer comprising the data may be smaller than the first threshold, c) the data may be configured for SDT, and d) the data may be the SDT, terminated at the wireless device 130.

In some examples, the report may comprise parameters such as CQI, RAI, multi-Transport Block (TB) scheduling and/or UE assistance information.

In some embodiments, the first indication may indicate one of: a) the wireless device 130 is to use RA resources and report the CQI in Msg3 or MsgA, b) the wireless device 130 is to use RA resources, select the preamble from preamble group B and report CQI in Msg3 or MsgA, c) the wireless device 130 is to use RA-SDT resources and report CQI in Msg3 or MsgA, and d) the wireless device 130 is to report CQI using UCI on the PUCCH.

### Action 302

In this Action 302, the network node 110 receives the report.

The receiving in this Action 302 is from the wireless device 130 operating in the wireless communications network 100.

The report is of the first indicator of the signal to noise ratio in the channel between the network node 110 and the wireless device 130, in inactive state. The receiving is as part of the procedure to transmit data from the network node 110 to the wireless device 130 while the wireless device 130 is in inactive state.

The receiving in this Action 302 may be performed, e.g., via the first link 141.

The receiving in this Action 302 of the report may be in one of:
i. the Message 3 or the Message A of the random access procedure,
ii. the common or dedicated UCI on the PUCCH,
iii. the PUCCH resources that may be specific for SDT,
iv. the PUCCH resources selected autonomously by the wireless device 130,
v. the PUSCH, and
vi. in the PUCCH and the PUSCH resources.

The receiving in this Action 302 of report may be based on the one or more conditions, such as for example, whether the signal strength threshold, e.g., RSRP threshold, may be exceeded or not.

The receiving in this Action 302 of the report may be based on the sent first indication.

In some embodiments, the receiving in this Action 302 of report may be in PUCCH, and the sent first indication may comprise at least one of: a) the index of the PUCCH resources, b) the second indication of whether resources of the PUCCH may be common or dedicated, and c) the PUCCH-ConfigCommon IE.

In some examples related to embodiments herein, the network node 110 may fail to receive the report with the proviso the second indicator of the quality of the channel may be below the second threshold.

In some embodiments, the method may optionally further comprise the following action:

In some embodiments, at least one of the following may apply: a) the report may comprise the CQI, b) the size of the buffer comprising the data may be smaller than the first threshold, c) the data may be configured for SDT, and d) the data may be the SDT, terminated at the wireless device 130.

In some embodiments, the method may further comprise one or more of the following actions.

### Action 303

In this Action 303, network node 110 may optionally determine which second resources to use to send the data to the wireless device 130.

Determining may be understood as deciding, selecting, or similar.

The determining in this Action 303 may be based on the received report.

In some embodiments, the method may further comprise the following action.

### Action 304

In this Action 304, the network node 110 may send the data.

The sending in this Action 304 may be to the wireless device 130.

The sending in this Action 304 may be performed, e.g., via the first link 141.

The sending in this Action 304 may be based on the received report.

The sending in this Action 304 of the data may be optionally based on the determined second resources.

As a summarized overview of the foregoing, according to embodiments herein, when the wireless device 130 may be paged to initiate an MT-SDT procedure, the paging message or other message may indicate how to select the CQI feedback method.

Alternatively, when the wireless device 130 may have determined the indicator, e.g., the CQI, it may select the reporting procedure based on different factors, e.g., Msg3 grant size, PUSCH size in MsgA, and/or the outcome of the RSRP or CQI measurements or priority of the data.

Certain embodiments disclosed herein may provide one or more of the following technical advantage(s), which may be summarized as follows.

Embodiments herein, may be understood to specify how to report the first indicator of the signal to noise ratio, e.g., the CQI, to the network, e.g., to the network node 110. This may ensure that the first indicator of the signal to noise ratio, e.g., the CQI, may be reported to the network, e.g., to the network node 110, in an efficient way.

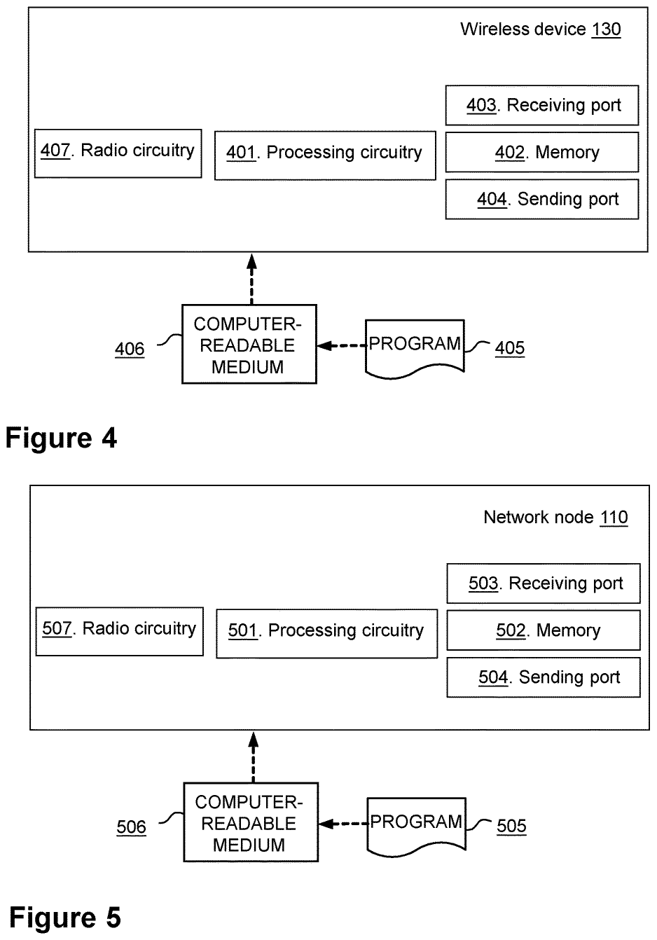

FIG. 4 depicts an example of the arrangement that the wireless device 130 may comprise to perform the method actions described above in relation to FIG. 2. The wireless device 130 may be understood to be for handling the indication. The wireless device 130 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here. For example, the connected mode may be an RRC connected mode.

The wireless device 130 is configured and/or operable to perform the obtaining in Action 201, e.g. by means of a processing circuitry 401 within the wireless device, configured to, obtain the first indication. The first indication is configured to indicate that the wireless device 130 is to report, to the network node 110 configured to operate in the wireless communications network 100, the first indicator of the signal to noise ratio in the channel between the wireless device 130 and the network node 110 in inactive state, as part of a procedure to transmit data from the network node 110 to the wireless device 130 while the wireless device 130 is in inactive state.

In some embodiments, the obtaining of the first indication may be configured to be one of the following: a) in the paging message from the network node 110, b) in the Message 2 of the random access procedure, c) via SI, d) in the RRCRelease message, e) in the pre-configuration, f) in DCI, and g) in RRC signalling.

In some embodiments, at least one of the following may apply: i) the report may be configured to comprise the CQI, ii) the size of a buffer configured to comprise the data may be configured to be smaller than the first threshold, iii) the data may be configured for SDT, and iv) the data may be configured to be an SDT, terminated at the wireless device 130.

In some embodiments, the first indication may be configured to indicate one of: a) the wireless device 130 is to use RA resources and report CQI in Msg3 or MsgA, b) the wireless device 130 is to use RA resources, select the preamble from preamble group B and report CQI in Msg3 or MsgA, c) the wireless device 130 is to use RA-SDT resources and report CQI in Msg3 or MsgA, and d) the wireless device 130 is to report CQI using UCI on the PUCCH.

In some embodiments, the wireless device 130 may be configured with at least one of the following three configurations.

The wireless device 130 may be configured and/or operable to perform the determining in Action 202, e.g. by means of the processing circuitry 401 within the wireless device 130, configured to determine which first resources to use to send the report to the network node 110 based on the first indication configured to be obtained.

The wireless device 130 may be configured and/or operable to perform the sending in Action 203, e.g., by means of the processing circuitry 401, configured to send, on the first resources configured to be determined, the report to the network node 110 based on the first indication configured to be obtained.

The wireless device 130 may be configured and/or operable to perform the receiving in Action 204, e.g. by means of the processing circuitry 401, configured to receive the data from the network node 110 based on the report configured to be sent.

In some embodiments, at least one of the following options may apply. According to a first option, the sending of the report may be configured to be in one of: i) the Message 3 or a Message A of the random access procedure, ii) common or dedicated UCI on the PUCCH, iii) PUCCH resources that are specific for SDT, iv) PUCCH resources configured to be selected autonomously by the wireless device 130, v) the PUSCH, and vi) in PUCCH and PUSCH resources. According to a second option, the determining of the first resources may be configured to be based on the one or more conditions.

In some embodiments, the sending of the report may be configured to be in PUCCH, and the first indication configured to be obtained may be configured to comprise at least one of: i) the index of the PUCCH resources, ii) the second indication of whether resources of the PUCCH are common or dedicated, and iii) the PUCCH-ConfigCommon IE.

In some embodiments, the wireless device 130 may be configured to refrain from sending the report with the proviso the second indicator of the quality of the channel may be below the second threshold.

The embodiments herein in the wireless device 130 may be implemented through one or more processors, such as a processing circuitry 401 in the wireless device 130 depicted in FIG. 4a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The processing circuitry 401 may be configured to, or operable to, perform the method actions according to FIG. 2.

The wireless device 130 may further comprise a memory 402 comprising one or more memory units. The memory 402 is arranged to be used to store obtained information, store data, configurations, schedulings, and applications etc. to perform the methods herein when being executed in the wireless device 130.

In some embodiments, the wireless device 130 may receive information from, e.g., the network node 110 or another structure in the wireless communications network 100, through a receiving port 403. In some embodiments, the receiving port 403 may be, for example, connected to one or more antennas in wireless device 130. In other embodiments, the wireless device 130 may receive information from another structure in the wireless communications network 100 through the receiving port 403. Since the receiving port 403 may be in communication with the processing circuitry 401, the receiving port 403 may then send the received information to the processing circuitry 401. The receiving port 403 may also be configured to receive other information.

The processing circuitry 401 in the wireless device 130 may be further configured to transmit or send information to e.g., the network node 110 or another structure in the wireless communications network 100, through a sending port 404, which may be in communication with the processing circuitry 401, and the memory 402.

Those skilled in the art will also appreciate that the processing circuitry 401 described above may comprise a combination of analog and digital modules, and/or one or more processors configured with software and/or firmware, e.g., stored in memory, that, when executed by the one or more processors such as the processing circuitry 401, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the wireless device 130 may be configured to perform the actions of FIG. 2 with respective units that may be implemented as one or more applications running on one or more processors such as the processing circuitry 401.

Thus, the methods according to the embodiments described herein for the wireless device 130 may be respectively implemented by means of a computer program 405 product, comprising instructions, i.e., software code portions, which, when executed on at least one processing circuitry 401, cause the at least one processing circuitry 401 to carry out the actions described herein, as performed by the wireless device 130. The computer program 405 product may be stored on a computer-readable storage medium 406. The computer-readable storage medium 406, having stored there on the computer program 405, may comprise instructions which, when executed on at least one processing circuitry 401, cause the at least one processing circuitry 401 to carry out the actions described herein, as performed by the wireless device 130. In some embodiments, the computer-readable storage medium 406 may be a non-transitory computer-readable storage medium, such as a CD ROM disc, or a memory stick. In other embodiments, the computer program 405 product may be stored on a carrier containing the computer program 405 just described, wherein the carrier is one of an electronic signal, optical signal, radio signal, or the computer-readable storage medium 406, as described above.

The wireless device 130 may comprise a communication interface configured to facilitate communications between the wireless device 130 and other nodes or devices, e.g., the network node 110 or another structure in the wireless communications network 100. The interface may, for example, include a transceiver configured to transmit and receive radio signals over an air interface in accordance with a suitable standard.

In other embodiments, the wireless device 130 may also comprise a radio circuitry 407, which may comprise e.g., the receiving port 403 and the sending port 404. The radio circuitry 407 may be configured to set up and maintain at least a wireless connection with the network node 110 or another structure in the wireless communications network 100. Circuitry may be understood herein as a hardware component.

Hence, embodiments herein also relate to the wireless device 130 comprising the processing circuitry 401 and the memory 402, said memory 402 containing instructions executable by said processing circuitry 401, whereby the wireless device 130 is operative to perform the actions described herein in relation to the wireless device 130, e.g., in FIG. 2.

FIG. 5 depicts an example of the arrangement that the network node 110 may comprise to perform the method actions described above in relation to FIG. 3. The network node 110 may be understood to be for handling the indication. The network node 110 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the network node 110 and will thus not be repeated here. For example, the connected mode may be an RRC connected mode.

The network node 110 is configured and/or operable to perform the receiving in Action 302, e.g. by means of the processing circuitry 501, configured to, receive from the wireless device 130 configured to operate in the wireless communications network 100, the report of the first indicator of the signal to noise ratio in the channel between the network node 110 and the wireless device 130, in inactive state, as part of the procedure to transmit data from the network node 110 to the wireless device 130 while the wireless device 130 is in inactive state.

In some embodiments, at least one of the following options may apply. According to a first option, the report may be configured to comprise the CQI. According to a second option, the size of the buffer configured to comprise the data may be configured to be smaller than the first threshold. According to a third option, the data may be configured for SDT. According to a fourth option, the data may be configured to be an SDT, terminated at the wireless device 130. According to a fifth option, the receiving of the report may be configured to be in one of: i) the Message 3 or a Message A of the random access procedure, ii) common or dedicated UCI on the PUCCH, iii) PUCCH resources that are configured to be specific for SDT, iv) PUCCH resources configured to be selected autonomously by the wireless device 130, v) the PUSCH, and vi) in PUCCH and PUSCH resources. According to a sixth option, the receiving of the report may be based on the one or more conditions.

In some embodiments, the network node 110 may be further configured with the following configuration.

The network node 110 may be configured and/or operable to perform the sending in Action 301, e.g. by means of a processing circuitry 501 within the network node 110, configured to, send the first indication to the wireless device 130, the first indication being configured to indicate that the wireless device 130 is to report to the network node 110, the first indicator of the signal to noise ratio in the channel between the network node 110 and the wireless device 130, in inactive state, as part of the procedure to transmit data from the network node 110 to the wireless device 130 while the wireless device 130 is in inactive state.

In some embodiments, the sending of the first indication may be configured to be one of the following: a) in the paging message from the network node 110, b) in the Message 2 of the random access procedure, c) via SI, d) in the RRCRelease message, e) in the pre-configuration, f) in DCI, and g) in RRC signalling.

In some embodiments, the first indication may be configured to indicate one of: a) the wireless device 130 is to use RA resources and report CQI in Msg3 or MsgA, b) the wireless device 130 is to use RA resources, select the preamble from preamble group B and report CQI in Msg3 or MsgA, c) the wireless device 130 is to use RA-SDT resources and report CQI in Msg3 or MsgA, and d) the wireless device 130 is to report CQI using UCI on the PUCCH.

In some embodiments, the receiving of the report may be configured to be based on the first indication configured to be sent.

In some embodiments, the receiving of the report may be configured to be in PUCCH, and the first indication configured to be sent may be configured to comprise at least one of: i) the index of the PUCCH resources, ii) the second indication of whether resources of the PUCCH are common or dedicated, and iii) the PUCCH-ConfigCommon IE.

In some embodiments, the network node 110 may be further configured with at least one of the following two configurations.

The network node 110 may be configured and/or operable to perform the determining in Action 303, e.g. by means of the processing circuitry 501 within the network node 110, configured to, send the data to the wireless device 130 based on the report configured to be received.

The network node 110 may be configured and/or operable to perform the sending in Action 304, e.g. by means of the processing circuitry 601 within the network node 110, configured to, determine which second resources to use to send the data to the wireless device 130 based on the report configured to be received. The sending of the data may be configured to be based on the second resources. configured to be determined.

The embodiments herein in the network node 110 may be implemented through one or more processors, such as a processing circuitry 501 in the network node 110 depicted in FIG. 5a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The processing circuitry 501 may be configured to, or operable to, perform the method actions according to FIG. 3.

The network node 110 may further comprise a memory 502 comprising one or more memory units. The memory 502 is arranged to be used to store obtained information, store data, configurations, schedulings, and applications etc. to perform the methods herein when being executed in the network node 110.

In some embodiments, the network node 110 may receive information from, e.g., the wireless device 130 and/or another structure in the wireless communications network 100, through a receiving port 503. In some embodiments, the receiving port 503 may be, for example, connected to one or more antennas in network node 110. In other embodiments, the network node 110 may receive information from another structure in the wireless communications network 100 through the receiving port 503. Since the receiving port 503 may be in communication with the processing circuitry 501, the receiving port 503 may then send the received information to the processing circuitry 501. The receiving port 503 may also be configured to receive other information.

The processing circuitry 501 in the network node 110 may be further configured to transmit or send information to e.g., the wireless device 130 and/or another structure in the wireless communications network 100, through a sending port 504, which may be in communication with the processing circuitry 501, and the memory 502.

Those skilled in the art will also appreciate that the processing circuitry 501 described above may comprise a combination of analog and digital modules, and/or one or more processors configured with software and/or firmware, e.g., stored in memory, that, when executed by the one or more processors such as the processing circuitry 501, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the network node 110 may be configured to perform the actions of FIG. 3 with respective units that may be implemented as one or more applications running on one or more processors such as the processing circuitry 501.

Thus, the methods according to the embodiments described herein for the network node 110 may be respectively implemented by means of a computer program 505 product, comprising instructions, i.e., software code portions, which, when executed on at least one processing circuitry 501, cause the at least one processing circuitry 501 to carry out the actions described herein, as performed by the network node 110. The computer program 505 product may be stored on a computer-readable storage medium 506. The computer-readable storage medium 506, having stored thereon the computer program 505, may comprise instructions which, when executed on at least one processing circuitry 501, cause the at least one processing circuitry 501 to carry out the actions described herein, as performed by the network node 110. In some embodiments, the computer-readable storage medium 506 may be a non-transitory computer-readable storage medium, such as a CD ROM disc, or a memory stick. In other embodiments, the computer program 505 product may be stored on a carrier containing the computer program 505 just described, wherein the carrier is one of an electronic signal, optical signal, radio signal, or the computer-readable storage medium 506, as described above.

The network node 110 may comprise a communication interface configured to facilitate communications between the network node 110 and other nodes or devices, e.g., the wireless device 130 and/or another structure in the wireless communications network 100. The interface may, for example, include a transceiver configured to transmit and receive radio signals over an air interface in accordance with a suitable standard.

In other embodiments, the network node 110 may also comprise a radio circuitry 507, which may comprise e.g., the receiving port 503 and the sending port 504. The radio circuitry 507 may be configured to set up and maintain at least a wireless connection with the wireless device 130 and/or another structure in the wireless communications network 100. Circuitry may be understood herein as a hardware component.

Hence, embodiments herein also relate to the network node 110 comprising the processing circuitry 501 and the memory 502, said memory 502 containing instructions executable by said processing circuitry 501, whereby the network node 110 is operative to perform the actions described herein in relation to the network node 110, e.g., in FIG. 3.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### EXAMPLES RELATED TO EMBODIMENTS HEREIN

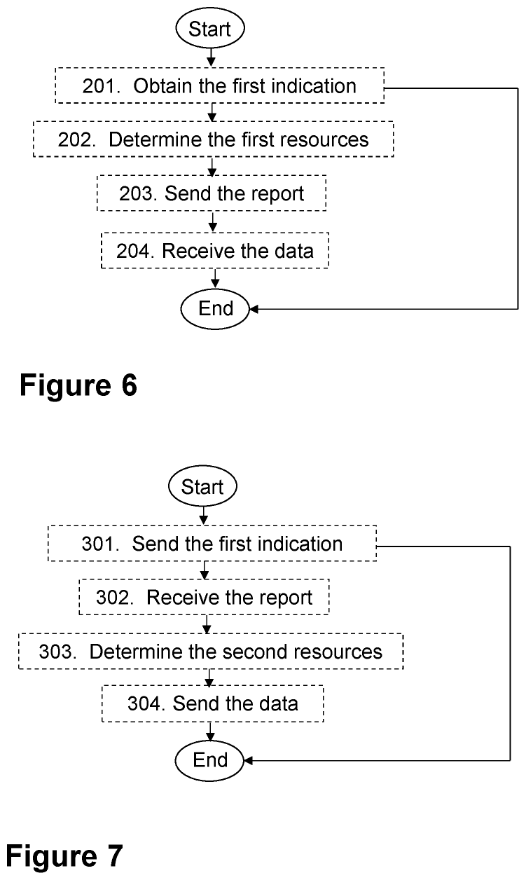

FIG. 6 depicts a method performed by the wireless device 130 in examples related to embodiments herein, according to the description of the actions provided in relation to FIG. 2.

The wireless device 130 examples relate to FIG. 6, FIG. 4 and FIGS. 8-13.

A method, performed by a wireless device, such as the wireless device 130 is described herein. The method may be understood to be for handling an indication. The wireless device 130 may be operating in a wireless communications network, such as the wireless communications network 100.

In some examples, the wireless communications network 100 may support, or operate in, New Radio (NR).

The method may comprise one or more of the following actions. In particular examples, the method may comprise Action 201. In some examples, all the actions may be performed. One or more examples may be combined, where applicable. Components from one example may be tacitly assumed to be present in another example and it will be obvious to a person skilled in the art how those components may be used in the other exemplary examples. All possible combinations are not described to simplify the description. A non-limiting example of the method performed by the wireless device 130 is depicted in FIG. 6. In FIG. 6 optional actions in some examples may be represented with dashed lines. In some examples, the actions may be performed in a different order than that depicted FIG. 6.
Obtaining 201 a first indication. The wireless device 130 may be configured and/or operable to perform the obtaining in this Action 201.

Obtaining may comprise receiving, e.g., via the first link 141, from the network node 110 or another network node, or device, or retrieving, e.g., from a memory.

The first indication may indicate that the wireless device 130 may have to report, to the network node 110, a first indicator. The first indicator may be of a signal to noise ratio in a channel between the wireless device 130 and the network node 110, e.g., in inactive state.

The first indication may indicate that the wireless device 130 may have to report the first indicator as part of a procedure to transmit data from the network node 110 to the wireless device 130 while the wireless device 130 is in inactive state.

A size of a buffer comprising the data may be smaller than a threshold. That is, the data may be small data, e.g., an SDT. In other words, the data may be configured for SDT, e.g., MT-SDT.

In some examples, the obtaining in this Action 201 of the first indication may be one of:
in a paging message from the network node 110,
in a Message 2 of a random access procedure,
via System Information (SI),
in an RRCRelease message,
in a pre-configuration,
in Downlink Control Information (DCI), and
in Radio Resource Control (RRC) signalling.

In some examples, at least one of the following may apply:
the report may comprise a Channel Quality Indicator (CQI), and
the data may be an SDT, terminated at the wireless device 130.

In some examples, the report may comprise parameters such as CQI, RAI, multi-Transport Block (TB) scheduling and/or UE assistance information.

In some examples, the first indication may indicate one of:
the wireless device 130 is to use random access (RA) resources and report CQI in Msg3 or MsgA,
the wireless device 130 is to use RA resources, select a preamble from preamble group B and report CQI in Msg3 or MsgA,
the wireless device 130 is to use RA-SDT resources and report CQI in Msg3 or MsgA, and
the wireless device 130 is to report CQI using Uplink Control Information (UCI) on a Physical Uplink Control Channel (PUCCH).

In some examples, the method may further comprise one or more of the following actions:
Determining 202 which first resources to use to send the report to the network node 110. The wireless device 130 may be configured and/or operable to perform the determining in this Action 202.

Determining may be understood as calculating, selecting or deriving.

The determining in this Action 202 may be based on the obtained first indication.

The determining in this Action 202 of the first resources may be based on one or more conditions, such as for example, whether a signal strength threshold, e.g., RSRP threshold, may have been exceeded or not.
Sending 203 the report. The wireless device 130 may be configured and/or operable to perform the sending in this Action 203.

The sending in this Action 203 may be to the network node 110.

The sending in this Action 203 may be, e.g., transmitting, and may be performed, e.g., via the first link 141.

The sending in this Action 203 may be on the determined first resources.

The sending in this Action 203 may be based on the obtained first indication.

The sending of the report in this Action 203 may be in one of:
i. a Message 3 or a Message A of a random access procedure, and
ii. common or dedicated UCI on a PUCCH,
iii. PUCCH resources that may be specific for SDT,
iv. PUCCH resources selected autonomously by the wireless device 130,
v. a Physical Uplink Shared Channel (PUSCH), and
vi. in PUCCH and PUSCH resources.

In some examples, the sending 203 of the report may be in PUCCH, and the obtained first indication may comprise at least one of:
an index of the PUCCH resources,
a second indication of whether resources of the PUCCH are common or dedicated, and
a PUCCH-ConfigCommon Information Element (IE).
   Receiving 204 the data. The wireless device 130 may be configured and/or operable to perform the receiving in this Action 204.

The receiving in this Action 204 may be from the network node 110.

The receiving in this Action 204 may be performed, e.g., via the first link 141.

The receiving in this Action 204 may be based on the sent report.

In some examples, the wireless device 130 may refrain from sending the report with the proviso a second indicator of a quality of the channel is below a threshold.

In FIG. 6, optional units are indicated with dashed boxes.

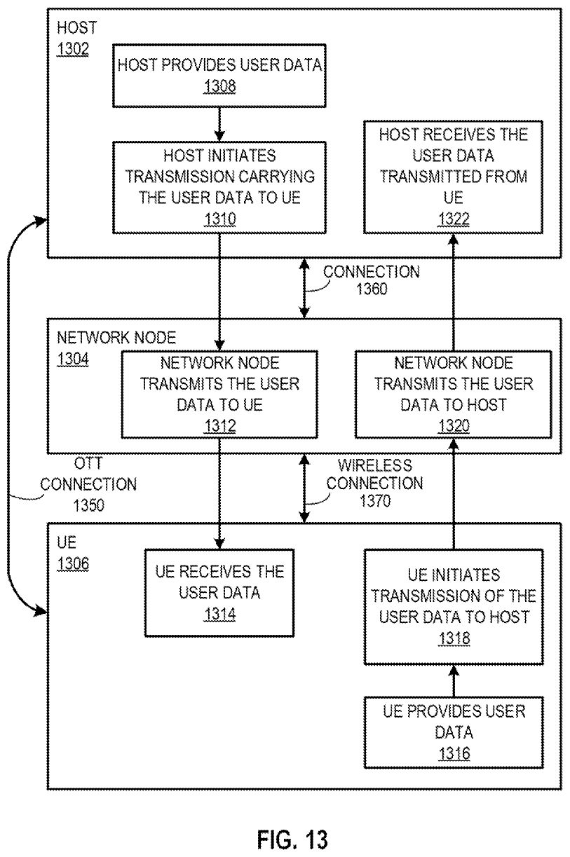

The wireless device 130 may comprise an arrangement as shown in FIG. 4 or in FIG. 13.

FIG. 7 depicts a method performed by the network node 110 in examples related to embodiments herein, according to the description of the actions provided in relation to FIG. 3.

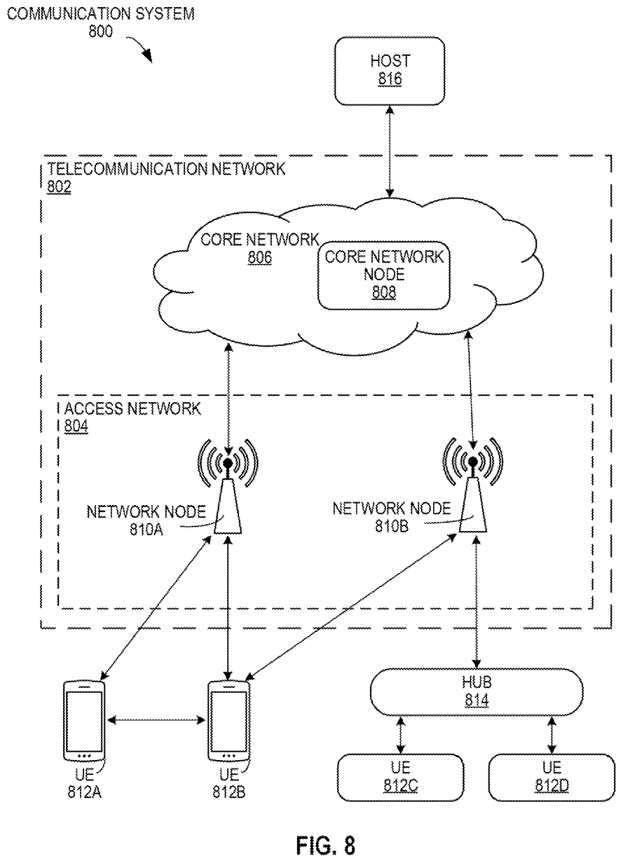

The network node 110 examples relate to FIG. 7, FIG. 5, and FIGS. 8-13.

A method, performed by a network node, such as the network node 110 is described herein. The method may be understood to be for handling the indication. The network node 110 may be operating in a wireless communications network, such as the wireless communications network 100.

In some examples, the wireless communications network 100 may support New Radio (NR).

The first method may comprise one or more of the following actions. In a particular non-limiting example, Action 301 may be performed. In some examples, all the actions may be performed. One or more examples may be combined, where applicable. Components from one example may be tacitly assumed to be present in another example and it will be obvious to a person skilled in the art how those components may be used in the other exemplary examples. All possible combinations are not described to simplify the description. A non-limiting example of the method performed by the network node 110 is depicted in FIG. 7. In FIG. 7, optional actions in some examples may be represented with dashed lines. In some examples, the actions may be performed in a different order than that depicted FIG. 7.

The detailed description of some of the following corresponds to the same references provided above, in relation to the actions described for the wireless device 130 and will thus not be repeated here to simplify the description. For example, the data may be SDT.
Sending 301 the first indication. The network node 110 may be configured and/or operable to perform the sending in this Action 301.

The sending in this Action 301 may be to the wireless device 130.

The sending in this Action 301 may be performed, e.g., via the first link 141.

The first indication may indicate that the wireless device 130 is to report to the network node 110, the first indicator.

The first indicator is of the signal to noise ratio in the channel between the network node 110 and the wireless device 130, e.g., in inactive state.

The sending in this Action 301 of the first indication may be performed as part of the procedure to transmit data from the network node 110 to the wireless device 130 while the wireless device 130 is in inactive state.

The size of the buffer comprising the data may be smaller than the threshold. That is, the data may be configured for SDT.

The sending in this Action 301 of the first indication may be one of:
in the paging message from the network node 110,
in the Message 2 of the random access procedure,
via the SI,
in the RRCRelease message,
in the pre-configuration,
in the DCI, and
in the RRC, signalling.

In some examples, at least one of the following may apply:
the report may comprise the CQI, and
the data may be the SDT, terminated at the wireless device 130.

In some examples, the report may comprise parameters such as CQI, RAI, multi-Transport Block (TB) scheduling and/or UE assistance information.

In some examples, the first indication may indicate one of:
the wireless device 130 is to use RA resources and report CQI in Msg3 or MsgA,
the wireless device 130 is to use RA resources, select the preamble from preamble group B and report CQI in Msg3 or MsgA,
the wireless device 130 is to use RA-SDT resources and report CQI in Msg3 or MsgA, and
the wireless device 130 is to report CQI using UCI on a PUCCH.

In some examples, the method may further comprise one or more of the following actions:
Receiving 302 the report. The network node 110 may be configured and/or operable to perform the receiving in this Action 302.

The receiving in this Action 302 may be from the wireless device 130.

The receiving in this Action 302 may be performed, e.g., via the first link 141.

The receiving in this Action 302 of the report may be based on the sent first indication.

The receiving in this Action 302 of report may be in one of:
i. the Message 3 or the Message A of the random access procedure,
ii. the common or dedicated UCI on the PUCCH,
iii. the PUCCH resources that may be specific for SDT,
iv. the PUCCH resources selected autonomously by the wireless device 130,
v. the PUSCH, and
vi. in the PUCCH and the PUSCH resources.

The receiving in this Action 302 of report may be based on the one or more conditions, such as for example, whether the signal strength threshold, e.g., RSRP threshold, may be exceeded or not.

In some examples, the receiving in this Action 302 of report may be in PUCCH, and the obtained first indication may comprise at least one of:
the index of the PUCCH resources,
the second indication of whether resources of the PUCCH may be common or dedicated, and
the PUCCH-ConfigCommon IE.

In some examples, the network node 110 may fail to receive the report with the proviso the second indicator of the quality of the channel may be below the threshold.

In some examples, the method may optionally further comprise the following action:
Determining 303 which second resources to use to send the data to the wireless device 130. The network node 110 may be configured and/or operable to perform the determining in this Action 303.

Determining may be understood as deciding, selecting, or similar.

The determining in this Action 303 may be based on the received report.

In some examples, the method may further comprise one or more of the following actions:
Sending 304 the data. The network node 110 may be configured and/or operable to perform the sending in this Action 304.

The sending in this Action 304 may be to the wireless device 130.

The sending in this Action 304 may be performed, e.g., via the first link 141.

The sending in this Action 304 may be based on the received report.

The sending in this Action 304 may be optionally based on the determined second resources.

In FIG. 5, optional units are indicated with dashed boxes.

The network node 110 may comprise an arrangement as shown in FIG. 5 or in FIG. 13.

Selected examples related to embodiments herein:

EXAMPLE 1. A method performed by a wireless device (130), the method being for handling an indication, the wireless device (130) operating in a wireless communications network (100), and the method comprising:
obtaining (201) a first indication, the first indication indicating that the wireless device (130) is to report, to the network node (110), a first indicator of a signal to noise ratio in a channel between the wireless device (130) and the network node (110), e.g., in inactive state, as part of a procedure to transmit data from the network node (110) to the wireless device (130) while the wireless device (130) is in inactive state, wherein a size of a buffer comprising the data is smaller than a threshold/wherein the data is configured for Small Data Transmission, SDT.
   EXAMPLE 2. The method according to example 1, wherein the obtaining (201) of the first indication is one of:
in a paging message from the network node (110),
in a Message 2 of a random access procedure,
via System Information, SI,
in a RRCRelease message,
in a pre-configuration,
in Downlink Control Information, DCI, and
in Radio Resource Control, RRC, signalling.
   EXAMPLE 3. The method according to any of examples 1-2, wherein at least one of:
the report comprises a Channel Quality Indicator, CQI, and
the data is an SDT, terminated at the wireless device (130).
   EXAMPLE 4. The method according to any of examples 1-3, wherein the first indication indicates one of:
the wireless device (130) is to use random access, RA, resources and report CQI in Msg3 or MsgA,
the wireless device (130) is to use RA resources, select a preamble from preamble group B and report CQI in Msg3 or MsgA,
the wireless device (130) is to use RA-SDT resources and report CQI in Msg3 or MsgA, and
the wireless device (130) is to report CQI using Uplink Control Information, UCI, on a Physical Uplink Control Channel, PUCCH.
   EXAMPLE 5. The method according to any of examples 1-4, further comprising:
determining (202) which first resources to use to send the report to the network node (110) based on the obtained first indication,
sending (203), on the determined first resources, the report to the network node (110) based on the obtained first indication, and
receiving (204) the data from the network node (110) based on the sent report.
   EXAMPLE 6. The method according to example 4, wherein at least one of:
the sending (203) of the report is in one of:
   i. a Message 3 or a Message A of a random access procedure, and
   ii. common or dedicated UCI on a PUCCH,
   iii. PUCCH resources that are specific for SDT,
   iv. PUCCH resources selected autonomously by the wireless device (130),
   v. a Physical Uplink Shared Channel, PUSCH, and
   vi. in PUCCH and PUSCH resources, and
the determining (202) of the first resources is based on one or more conditions.
   EXAMPLE 7. The method according to example 5, wherein the sending (203) of the report is in PUCCH, and wherein the obtained first indication comprises at least one of:
an index of the PUCCH resources,
a second indication of whether resources of the PUCCH are common or dedicated, and
a PUCCH-ConfigCommon Information Element, IE.
   EXAMPLE 8. The method according to any of examples 1-4, wherein the wireless device (130) refrains from sending the report with the proviso a second indicator of a quality of the channel is below a threshold.
   EXAMPLE 9. A method performed by a network node (110), the method being for handling an indication, the network node (110) operating in a wireless communications network (100), and the method comprising:
sending (301) a first indication, the first indication indicating that the wireless device (130) is to report, to the wireless device (130), a first indicator of a signal to noise ratio in a channel between the network node (110) and the wireless device (130), e.g., in inactive state, as part of a procedure to transmit data from the network node (110) to the wireless device (130) while the wireless device (130) is in inactive state, wherein a size of a buffer comprising the data is smaller than a threshold/wherein the data is configured for Small Data Transmission, SDT.
   EXAMPLE 10. The method according to example 9, wherein the sending (301) of the first indication is one of:
in a paging message from the network node (110),
in a Message 2 of a random access procedure,
via System Information, SI,
in a RRCRelease message,
in a pre-configuration,
in Downlink Control Information, DCI, and
in Radio Resource Control, RRC, signalling.
   EXAMPLE 11. The method according to any of examples 9-10, wherein at least one of:
the report comprises a Channel Quality Indicator, CQI, and
the data is an SDT, terminated at the wireless device (130).
   EXAMPLE 12. The method according to any of examples 9-11, wherein the first indication indicates one of:
the wireless device (130) is to use random access, RA, resources and report CQI in Msg3 or MsgA,
the wireless device (130) is to use RA resources, select a preamble from preamble group B and report CQI in Msg3 or MsgA,
the wireless device (130) is to use RA-SDT resources and report CQI in Msg3 or MsgA, and
the wireless device (130) is to report CQI using Uplink Control Information, UCI, on a Physical Uplink Control Channel, PUCCH.
   EXAMPLE 13. The method according to any of examples 9-12, further comprising:
receiving (302) the report from the wireless device (130) based on the sent first indication,
optionally, determining (303) which second resources to use to send the data to the wireless device (130) based on the received report, and
sending (304) the data to the wireless device (130) based on the received report and, optionally, based on the determined second resources.
   EXAMPLE 14. The method according to example 13, wherein at least one of:
the receiving (302) of the report is in one of:
   i. a Message 3 or a Message A of a random access procedure,
   ii. common or dedicated UCI on a PUCCH,
   iii. PUCCH resources that are specific for SDT,
   iv. PUCCH resources selected autonomously by the wireless device (130),
   v. a Physical Uplink Shared Channel, PUSCH, and
   vi. in PUCCH and PUSCH resources, and
the receiving (302) of the report is based on one or more conditions.
   EXAMPLE 15. The method according to example 14, wherein the receiving (302) of the report is in PUCCH, and wherein the sent first indication comprises at least one of:
an index of the PUCCH resources,
a second indication of whether resources of the PUCCH are common or dedicated, and
a PUCCH-ConfigCommon Information Element, IE.
   EXAMPLE 16. The method according to any of examples 9-15, wherein the network node (110) fails to receive the report with the proviso a second indicator of a quality of the channel is below a threshold.

### Further Extensions and Variations

FIG. 8 shows an example of a communication system 800 in accordance with some embodiments.

In the example, the communication system 800, such as the wireless communications network 100, includes a telecommunication network 802 that includes an access network 804, such as a radio access network (RAN), and a core network 806, which includes one or more core network nodes 808. The access network 804 includes one or more access network nodes, such as the network node 110. For example, network nodes 810a and 810b (one or more of which may be generally referred to as network nodes 810), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 802 includes one or more Open-RAN (ORAN) network nodes. An ORAN network node is a node in the telecommunication network 802 that supports an ORAN specification (e.g., a specification published by the O-RAN Alliance, or any similar organization) and may operate alone or together with other nodes to implement one or more functionalities of any node in the telecommunication network 802, including one or more network nodes 810 and/or core network nodes 808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections. Any of the UEs 812a, 812b, 812c, and 812d are examples of the wireless device 130.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The wireless device 130, exemplified in FIG. 8 as the UEs 812 may be any of a wide variety of communication devices, including wireless devices arranged, configured, and/or operable to communicate wirelessly with the network node 110, exemplified in FIG. 8 as network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

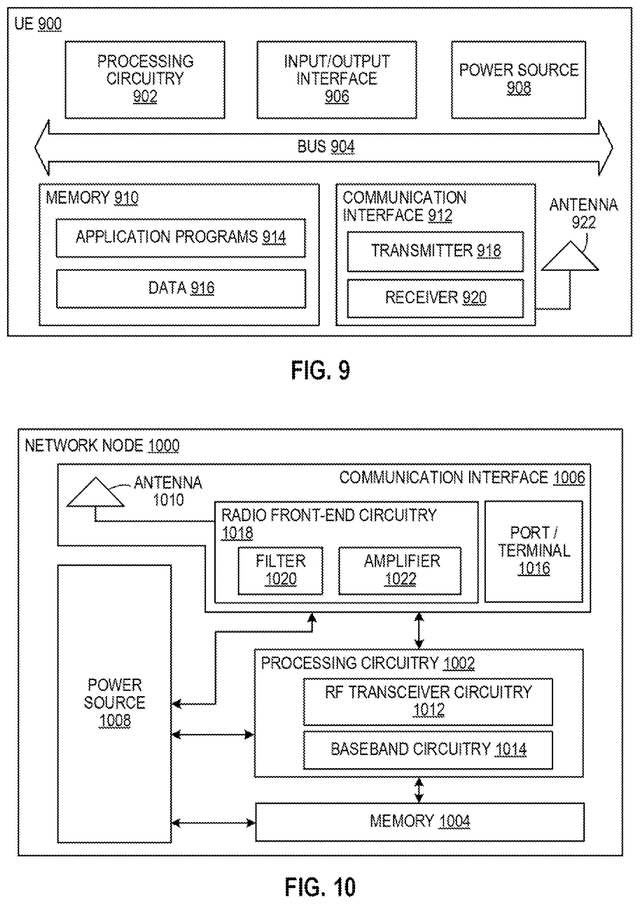

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

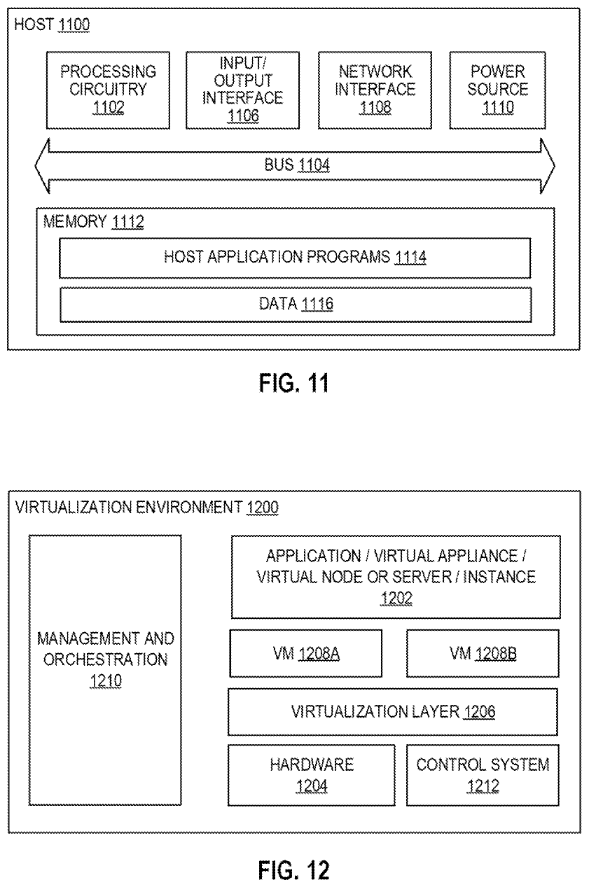

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1200 includes components defined by the O-RAN Alliance, such as an O-Cloud environment orchestrated by a Service Management and Orchestration Framework via an O-2 interface.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve data rate, latency, power consumption and thereby provide benefits such as reduced user waiting time, relaxed restriction on file size, improved content resolution, better responsiveness, and extended battery lifetime.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The wireless device 130 embodiments relate to FIG. 2, FIG. 4 and FIGS. 8-13.

The wireless device 130 may comprise an arrangement as shown in FIG. 4 or in FIG. 13.

The network node 110 embodiments relate to FIG. 3, FIG. 5, and FIGS. 8-13.

The network node 110 may comprise an arrangement as shown in FIG. 5 or in FIG. 13.

### FURTHER NUMBERED EMBODIMENTS

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by the network node 110.

2. The host of the previous embodiment, wherein:
the processing circuitry of the host is configured to execute a host application that provides the user data; and
the UE comprises processing circuitry configured to execute a client application associated with the host application to receive the transmission of user data from the host.

3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by the network node 110.

4. The method of the previous embodiment, further comprising, at the network node, transmitting the user data provided by the host for the UE.

5. The method of any of the previous 2 embodiments, wherein the user data is provided at the host by executing a host application that interacts with a client application executing on the UE, the client application being associated with the host application.

6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by the network node 110.

7. The communication system of the previous embodiment, further comprising:
the network node; and/or
the user equipment.

8. The communication system of the previous 2 embodiments, wherein:
the processing circuitry of the host is configured to execute a host application, thereby providing the user data; and
the host application is configured to interact with a client application executing on the UE, the client application being associated with the host application.

9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by the network node 110.

10. The host of the previous 2 embodiments, wherein:
the processing circuitry of the host is configured to execute a host application, thereby providing the user data; and
the host application is configured to interact with a client application executing on the UE, the client application being associated with the host application.

11. The host of the any of the previous 2 embodiments, wherein the initiating receipt of the user data comprises requesting the user data.

12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by the network node 110.

13. The method of the previous embodiment, further comprising at the network node, transmitting the received user data to the host.

14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform one or more of the actions described herein as performed by the wireless device 130.

15. The host of the previous embodiment, wherein the cellular network further includes a network node configured to communicate with the UE to transmit the user data to the UE from the host.

16. The host of the previous 2 embodiments, wherein:
the processing circuitry of the host is configured to execute a host application, thereby providing the user data; and
the host application is configured to interact with a client application executing on the UE, the client application being associated with the host application.

17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs one or more of the actions described herein as performed by the wireless device 130.

18. The method of the previous embodiment, further comprising:
at the host, executing a host application associated with a client application executing on the UE to receive the user data from the UE.

19. The method of the previous embodiment, further comprising:
at the host, transmitting input data to the client application executing on the UE, the input data being provided by executing the host application,
wherein the user data is provided by the client application in response to the input data from the host application.

20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform one or more of the actions described herein as performed by the wireless device 130.

21. The host of the previous embodiment, wherein the cellular network further includes a network node configured to communicate with the UE to transmit the user data from the UE to the host.

22. The host of the previous 2 embodiments, wherein:
the processing circuitry of the host is configured to execute a host application, thereby providing the user data; and
the host application is configured to interact with a client application executing on the UE, the client application being associated with the host application.

23. A method implemented by a host configured to operate in a communication system that further includes a network node and a user equipment (UE), the method comprising:
at the host, receiving user data transmitted to the host via the network node by the UE, wherein the UE performs one or more of the actions described herein as performed by the wireless device 130.

24. The method of the previous embodiment, further comprising:
at the host, executing a host application associated with a client application executing on the UE to receive the user data from the UE.

25. The method of the previous embodiments, further comprising:
at the host, transmitting input data to the client application executing on the UE, the input data being provided by executing the host application,
wherein the user data is provided by the client application in response to the input data from the host application.

1.-34. (canceled)

35. A wireless device, for handling an indication, the wireless device being configured to operate in a wireless communications network, and the wireless device comprising:
processing circuitry configured to obtain a first indication, the first indication being configured to indicate that the wireless device is to report, to a network node configured to operate in the wireless communications network, a first indicator of a signal to noise ratio in a channel between the wireless device and the network node in inactive state, as part of a procedure to transmit data from the network node to the wireless device while the wireless device is in inactive state.

36. The wireless device according to claim 35, wherein the processing circuitry is configured to obtain the first indication by one of:
in a paging message from the network node,
in a Message 2 of a random access procedure,
via System Information (SI),
in a RRCRelease message,
in a pre-configuration,
in Downlink Control Information (DCI), and
in Radio Resource Control (RRC) signalling.

37. The wireless device according to claim 35, wherein at least one of:
the report comprises a Channel Quality Indicator (CQI),
a size of a buffer comprising the data is smaller than a first threshold,
the data is for Small Data Transmission (SDT), and
the data is an SDT, terminated at the wireless device.

38. The wireless device according to claim 35, wherein the first indication indicates one of:
the wireless device is to use random access (RA) resources and report CQI in Msg3 or MsgA,
the wireless device is to use RA resources, select a preamble from preamble group B and report CQI in Msg3 or MsgA,
the wireless device is to use RA-SDT resources and report CQI in Msg3 or MsgA, and
the wireless device is to report CQI using Uplink Control Information (UCI) on a Physical Uplink Control Channel (PUCCH).

39. The wireless device according to claim 35, wherein the processing circuitry is configured to:
determine which first resources to use to send the report to the network node based on the first indication configured to be obtained,
send, on the first resources, the report to the network node based on the first indication, and
receive the data from the network node based on the report.

40. The wireless device according to claim 39, wherein at least one of:
the processing circuitry is configured to send the report in one of:
i. a Message 3 or a Message A of a random access procedure,
ii. common or dedicated UCI on a PUCCH,
iii. PUCCH resources that are configured to be specific for SDT,
iv. PUCCH resources configured to be selected autonomously by the wireless device,
v. a Physical Uplink Shared Channel (PUSCH), and
vi. in PUCCH and PUSCH resources, and
the processing circuitry is configured to determine the first resources based on one or more conditions.

41. The wireless device according to claim 40, wherein the processing circuitry is configured to send the report in PUCCH, and wherein the first indication comprises at least one of:
an index of the PUCCH resources,
a second indication of whether resources of the PUCCH are common or dedicated, and
a PUCCH-ConfigCommon Information Element (IE).

42. The wireless device according to claim 35, wherein the processing circuitry is configured to refrain from sending the report with the proviso a second indicator of a quality of the channel is below a second threshold.

43. A network node, for handling an indication, the network node being configured to operate in a wireless communications network, and the network node comprising:
processing circuitry configured to receive from a wireless device configured to operate in the wireless communications network, a report of a first indicator of a signal to noise ratio in a channel between the network node and the wireless device, in inactive state, as part of a procedure to transmit data from the network node to the wireless device while the wireless device is in inactive state.

44. The network node according to claim 43, wherein at least one of:
the report comprises a Channel Quality Indicator (CQ),
a size of a buffer comprising the data is smaller than a first threshold,
the data is for Small Data Transmission (SDT),
the data is an SDT, terminated at the wireless device,
the processing circuitry is configured to receive the report in one of:
i. a Message 3 or a Message A of a random access procedure,
ii. common or dedicated UCI on a PUCCH,
iii. PUCCH resources that are configured to be specific for SDT,
iv. PUCCH resources configured to be selected autonomously by the wireless device,
v. a Physical Uplink Shared Channel (PUSCH), and
vi. in PUCCH and PUSCH resources, and
the processing circuitry is configured to receive the report based on one or more conditions.

45. The network node according to claim 43, wherein the processing circuitry is configured to:
send a first indication to the wireless device, the first indication indicating that the wireless device is to report, to the network node, the first indicator of the signal to noise ratio in the channel between the network node and the wireless device, in inactive state, as part of the procedure to transmit data from the network node to the wireless device while the wireless device is in inactive state.

46. The network node according to claim 45, wherein the processing circuitry is configured to send the first indication:
in a paging message from the network node,
in a Message 2 of a random access procedure,
via System Information (SI),
in a RRCRelease message,
in a pre-configuration,
in Downlink Control Information (DCI), or
in Radio Resource Control (RRC) signalling.

47. The network node according to claim 45, wherein the first indication indicates one of:
the wireless device is to use random access (RA) resources and report CQI in Msg3 or MsgA,
the wireless device is to use RA resources, select a preamble from preamble group B and report CQI in Msg3 or MsgA,
the wireless device is to use RA-SDT resources and report CQI in Msg3 or MsgA, and
the wireless device is to report CQI using Uplink Control Information (UCI) on a Physical Uplink Control Channel (PUCCH).

48. The network node according to claim 45, wherein the processing circuitry is configured to receive the report based on the first indication.

49. The network node according to claim 45, wherein the processing circuitry is configured to receive the report in PUCCH, and wherein the first indication comprises at least one of:
an index of the PUCCH resources,
a second indication of whether resources of the PUCCH are common or dedicated, and
a PUCCH-ConfigCommon Information Element (IE).

50. The network node according to claim 45, the processing circuitry further configured to:
send the data to the wireless device based on the report.

51. The network node according to claim 50, the processing circuitry further configured to:
determine which second resources to use to send the data to the wireless device based on the report, and wherein the processing circuitry is configured to send the data based on the second resources.

52. A method performed by a wireless device, the method being for handling an indication, the wireless device operating in a wireless communications network, and the method comprising:
obtaining a first indication, the first indication indicating that the wireless device is to report, to a network node operating in the wireless communications network, a first indicator of a signal to noise ratio in a channel between the wireless device and the network node in inactive state, as part of a procedure to transmit data from the network node to the wireless device while the wireless device is in inactive state.

53. The method according to claim 52, wherein the obtaining of the first indication is one of:
in a paging message from the network node,
in a Message 2 of a random access procedure,
via System Information (SI),
in a RRCRelease message,
in a pre-configuration,
in Downlink Control Information (DCI), and
in Radio Resource Control (RRC) signalling.

54. A method performed by a network node, the method being for handling an indication, the network node operating in a wireless communications network, and the method comprising:
receiving, from a wireless device operating in the wireless communications network, a report of a first indicator of a signal to noise ratio in a channel between the network node and the wireless device, in inactive state, as part of a procedure to transmit data from the network node to the wireless device while the wireless device is in inactive state.
